(19) United States
(12) Patent Application Publication
(10) Pub. No.: US 2012/0091686 A1
(43) Pub. Date: Apr. 19, 2012

(54) BOOT REST FOR MOTORCYCLE ENGINE GUARD

(76) Inventor: RONALD M. HUTCHINSON, Brookfield, WI (US)

(21) Appl. No.: 13/277,027

(22) Filed: Oct. 19, 2011

Related U.S. Application Data
(60) Provisional application No. 61/394,494, filed on Oct. 19, 2010.

(51) Int. Cl. B62J 25/00

(52) U.S. Cl. 280/291

(57) ABSTRACT

A boot rest provides a boot rest body that is attached to an engine guard using a pair of clamp collars and fasteners. The boot rest body has a top surface and a plurality of apertures defined within that top surface. Disposed below the top surface is a rubber support insert. The insert has a plurality of upwardly projecting members, each of which is positioned below a like-configured aperture defined within the top surface of the boot rest body such that the members extend through the boot rest body and provide a gripping surface. A lip can also be provided for the outer-most upwardly projecting member so as to urge the operator's legs or boots inwardly of the motorcycle.

This application claims the benefit and priority of U.S. Provisional Patent Application No. 61/394,494 filed Oct. 19, 2010.

### FIELD OF THE INVENTION

The present invention relates generally to motorcycles and to motorcycle accessories. More specifically, the present invention relates to a boot rest that is mounted to the engine guards of a motorcycle.

### BACKGROUND OF THE INVENTION

Motorcycles are typically configured such that the motorcycle engine is located toward the front of the motorcycle frame and behind the front wheel struts. Because the motorcycle engine is fairly exposed to either side of the motorcycle frame, some manufacturers provide a bar or other similar structure forward of, and to either side of, the engine. Indeed, such bars have long been known in the motorcycle industry, including the “motorcycle protecting guard” that is disclosed and claimed in U.S. Pat. No. 1,941,801 to Harley, and such are typically referred to simply as “engine guards.” It is also well known in the motorcycle industry that engine guards are used to support the operator's or rider's feet or legs.

In the view of this inventor, one problem with the use of engine guards as a foot or leg support is that the typically chromed surface of the engine guard is a poor one for retention of the operator's feet or legs atop the engine guards. Accordingly, what is needed is a boot rest that can be easily and quickly attached and secured to the engine guard such that the operator's foot or leg can be retained atop the engine guard, particularly for shorter operators. What is also needed is such a boot rest that, when attached and secured to the engine guard, protects the chrome finish of the engine guard. What is also needed is such a boot rest that urges the operator's legs or feet inwardly to assist in boot or leg positioning at highway speeds.

Accordingly, it is an object of the present invention to provide a boot rest that can be securely attached to the engine guard of an existing motorcycle. It is also an object to provide such a boot rest that can be attached easily and quickly, that uses a minimal number of parts, steps and tools to do so and that protects the chrome finish of the engine guard once attached. It is a further object to provide such a boot rest that, once attached, assists the operator in supporting his or her feet or legs atop the engine guard and urges his or her feet or legs inwardly. It is yet another object to provide such a boot rest that is attractive in appearance and is aesthetically pleasing to the overall appearance of the motorcycle from an observer's or operator's perspective.

### SUMMARY OF THE INVENTION

The boot rest of the present invention has obtained these objects. It provides for a boot rest comprising a boot rest body that can be securely attached to an engine guard using a pair of clamp collars and a plurality of fasteners. The boot rest body has a top surface and a plurality of apertures defined within the top surface. Disposed below the top surface is a rubber support insert. The support insert is disposed between the engine guard and the boot rest body to protect the chrome finish of the engine guard once the boot rest has been attached. The insert has a plurality of upwardly projecting members. Each of the upwardly projecting members is positioned below a like configured aperture defined within the top surface of the boot rest body such that the projecting members extend through the boot rest body and provide a gripping surface for the operator. A lip is also provided in the outer-most upwardly projecting member so as to urge the operator's legs or boots inwardly of the motorcycle.

The foregoing and other features of the boot rest of the present invention will be apparent from the detailed description that follows.

### BRIEF DESCRIPTION OF THE DRAWINGS

FIG. 1 is a front, top and left side perspective view of a boot rest that is constructed in accordance with the present invention and showing the boot rest in exploded pre-assembly format together with the engine guard of a motorcycle.

FIG. 2 is a number of views of the body member of the boot rest shown in FIG. 1.

FIG. 3 is a number of views of the rubber support insert of the boot rest shown in FIG. 1.

FIG. 4 is a number of views of the clamp collar of the boot rest shown in FIG. 1.

### DETAILED DESCRIPTION

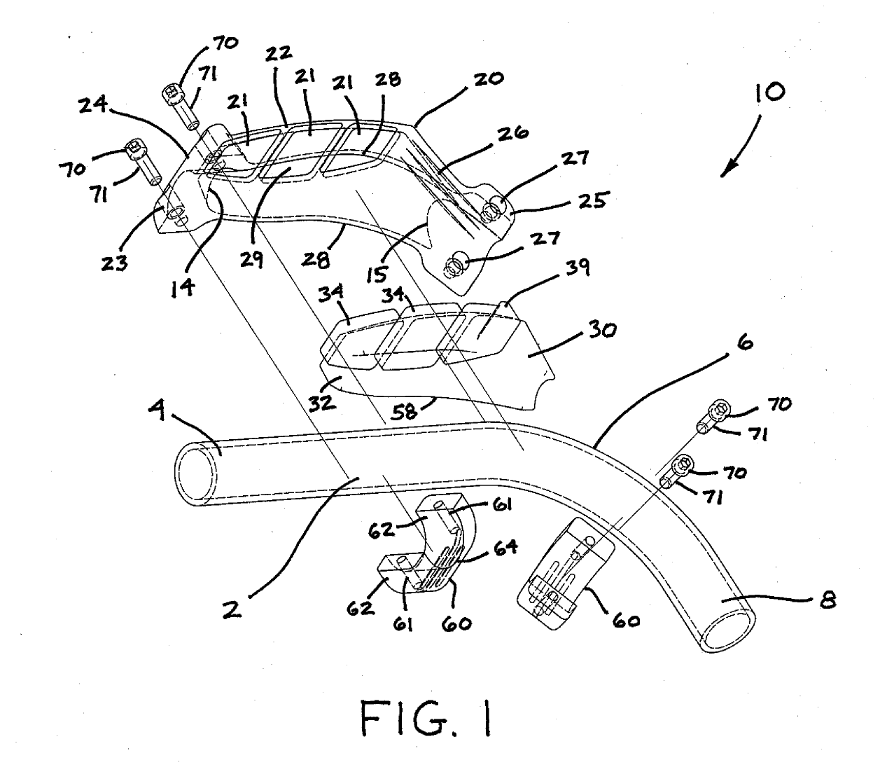

Referring now to the drawings in detail, wherein like numbered elements refer to like elements throughout, FIG. 1 illustrates a representative structure, generally identified 10, which is a preferred embodiment of a boot rest that is fabricated in accordance with the present invention. It should be noted here that, although the figures described in the “Brief Description of the Drawings” section of this Specification are identified for the engine guard that is disposed to the operator's right side of the motorcycle, there is a left side counterpart that the boot rest 10 of the present invention which can also be secured to without any change in its structure. A pair of such boot rests 10 would be used in the typical motorcycle application.

FIG. 1 illustrates the elements of the boot rest 10 prior to being attached to the engine guard 2 of a motorcycle (not shown). It is to be understood that the substantially tubular engine guard 2 comprises a horizontal portion 4, a vertical portion 8 and a curved portion 6 that is disposed between the horizontal and vertical portions 4, 8, respectively. It will be seen that the boot rest 10 comprises a body member 20, a boot rest rubber support insert 30, a pair of like-configured clamp collars 60 and a plurality of like-configured fasteners 70.

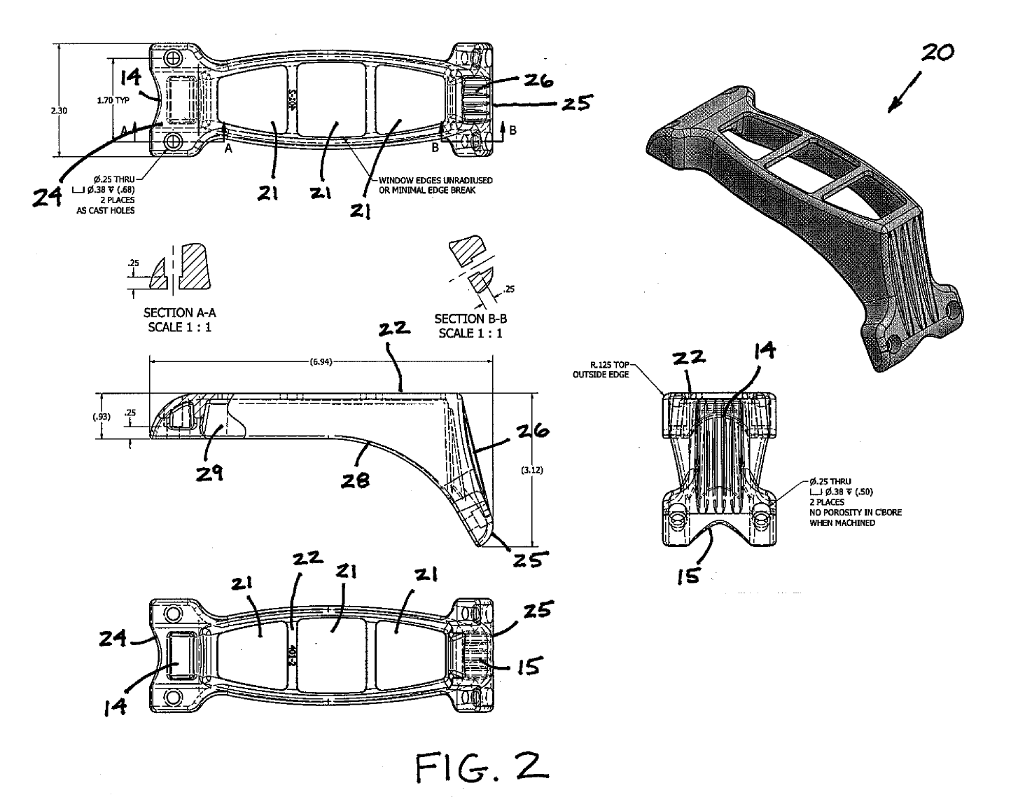

The body member 20 of the boot rest 10 further comprises a top surface 22 having a plurality of apertures 21 defined in it. See also FIG. 2. It should be noted that the number, shape and positioning of the apertures 21 is not a limitation of the present invention. The body member 20 further comprises an inner edge 24 and an outer edge 26. The inner edge 24 has a lowermost portion that defines an arched surface 14 in it. The inner edge 24 also comprises a pair of vertically-disposed holes 23 that are used with fasteners 70, as will be apparent later in this detailed description, to secure the body member 20 to the engine guard 2. The outer edge 26 of the body member 20 comprises a lowermost portion 25, the lowermost portion 25 likewise having an arched surface 15 and a pair of holes 27 that are defined in it. It is to be noted that the circumferential profile of the engine guard 6 substantially matches the arch profile of the arched surfaces 14, 15 of the inner and outer edges 24, 26, respectively. A cavity 29 is formed between forward and rearward edges 28 of the body member 20, the edges 28 being curved. It is also contemplated that the body member 20 could be chromed to enhance its appearance when applied to the chromed engine guard 2.

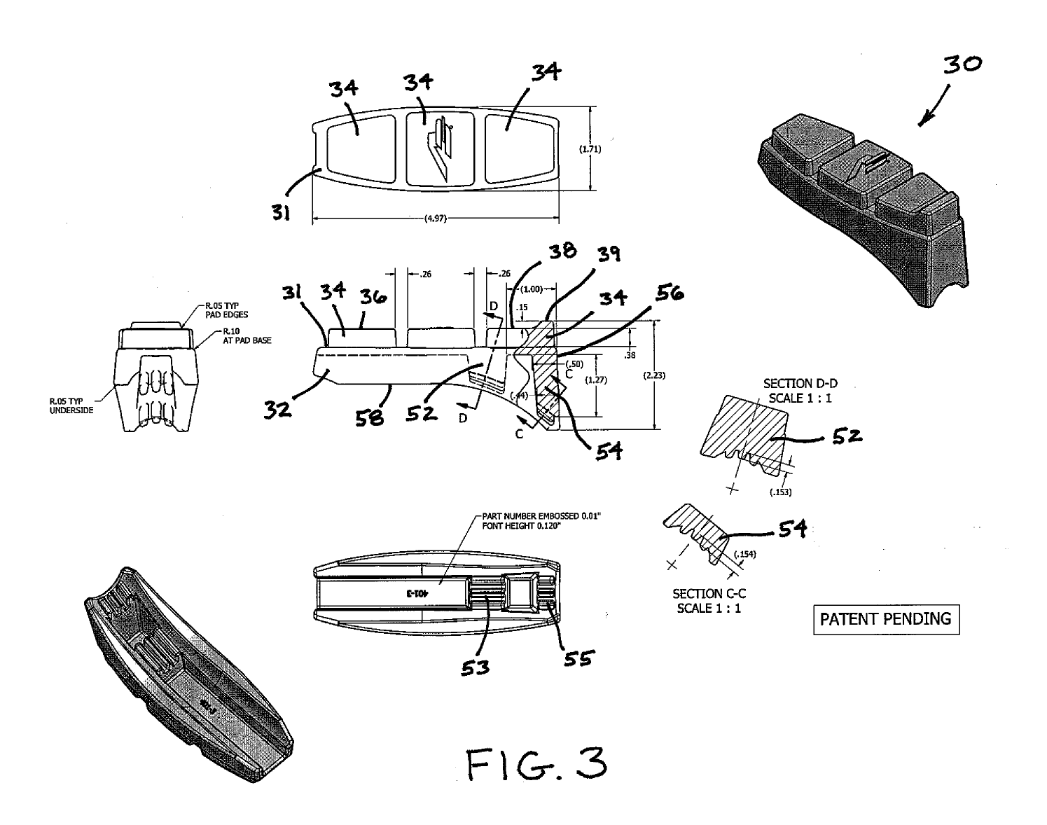

Disposed immediately below the top surface 22 of the body member 20 of the boot rest 10 is the boot rest rubber support insert 30. See FIG. 3. The precise formulation of the rubber material used to fabricate the support insert 30 is not a limitation of the present invention, although rubber of medium to high durometer is preferred. The support insert 30 comprises an insert body 32 having a top surface 31. The insert body 32, when viewed from the top, is configured so as to be received within the cavity 29 of the boot rest body member 20. Extending upwardly from the top surface 31 of the support insert 30 is a plurality of upwardly projecting members 34. The vertical profile of each upwardly projecting member 34 matches the shape of a like-positioned aperture 21 of the top surface 22 of the body member 20. It is also to be noted that the top surface 36 of each upwardly projecting member 34 is not necessarily the same. That is, the top surfaces 36 of the upwardly projecting members 34 that are disposed toward the inner edge 24 of the body member 20 are substantially flat. The top surface 38 of the upwardly projecting member 34 that is disposed toward the outer edge 26 of the body member 20 comprises a lip 39 which provides a surface that assists in urging the operator's boot or leg inwardly of the engine guard 2.

The support insert 30 further comprises a flat outer surface 56 and a curved bottom surface 58, the flat outer surface 56 being disposed in proximity to the outer edge 26 of the body member and the curved bottom surface 58 having a curve profile that substantially matches that of the curved portion 6 of the engine guard 2. The circumferential profile of the curved portion 6 of the engine guard 2 likewise matches the circumferential profile of the bottom surface 58 of the spacer 50. Inner and outer support members 52, 54, respectively, are also provided, each having a curved bottom surface 53, 55. This provides the design with a unique clamping surface. That is, there is a flat section aligned with fastener holes and relief cut on both sides of the clamping surface. This allows for clamping on a curved surface and also allows for some tolerance of fastener misalignment while insuring adequate generation of clamping force.

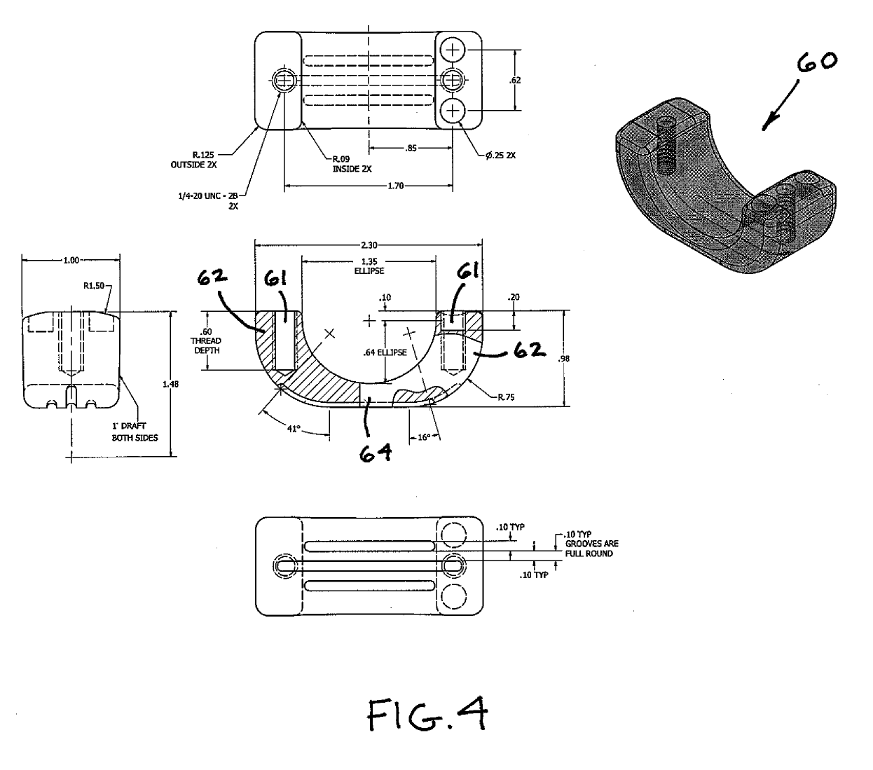

Securement of the boot rest 10 to the engine guard 2 is completed by use of the pair of clamp collars 60. See FIG. 4. Each clamp collar 60 comprises a pair of ends 62 between which extends an arched portion 64. The arched portion 64 matches the circumferential profile, or the circumferential outer diameter, of the engine guard 2. Each end 62 comprises a threaded aperture 61, the threads of the apertures 61 matching like threads 71 of the fasteners 70. It is also within the scope of the present invention that the apertures 61 of each clamp collar 60 have self-threading capability. Accordingly, it is contemplated by this inventor that securement of the boot rest 10 to the engine guard 2 can be accomplished quickly and easily, and with a single tool which would be a screwdriver or drive socket depending on the heads 72 that are configured into the fasteners 70.

In this configuration, and when the elements 20, 30, 60, 70 are secured in position, rotation of the boot rest 10 about the engine guard 2 is effectively prevented. The geometry of the boot rest 10 positions the clamp collars 60 in two different planes around the curve of the engine guard 2. This feature creates clamping forces in two different planes and establishes both an alignment feature and an additional locking force, i.e., beyond the clamping force of the two clamp collars 60.

In view of the foregoing, it will be apparent that there has been provided a new, useful and non-obvious boot rest for use with the engine guards of a motorcycle. The boot rest can that can be securely attached to the engine guards of an existing motorcycle, and this can be accomplished easily and quickly and by using a minimal number of parts, steps and tools to do so. Once attached, the boot rest assists the operator in supporting his or her feet or legs atop the engine guards and the profile of the upwardly projecting members of the rubber member urge the operator's leg or boot inwardly of the engine guard. Once attached, the boot rest is attractive in appearance and is aesthetically pleasing to the overall appearance of the motorcycle.

The details of the invention having been disclosed in accordance with the foregoing, I claim:

1. A boot rest for use with a motorcycle engine guard, the boot rest comprising:
a body member;
a rubber support insert;
a pair like-configured clamp collars; and
a plurality of like-configured fasteners.

2. The boot rest of claim 1 wherein the body member comprises:
a top surface, the top surface having a plurality of apertures defined in it;
an inner edge, the inner edge comprising a lowermost portion that defines an arched surface and a pair of vertically-disposed holes;
an outer edge, the outer edge comprising a lowermost portion having an arched surface and a pair of holes defined in the arched surface; and
a cavity formed between forward and rearward edges of the body member, the edges being curved.

3. The boot rest of claim 2 wherein the rubber support insert comprises:
a top surface;
a plurality of projecting members, the projecting members extending upwardly from the top surface of the rubber member and the vertical profile of each upward projecting member matching the shape of a like-positioned aperture of the top surface of the body member; and
a bottom surface having a curved profile that substantially matches a curved portion of the engine guard.

4. The boot rest of claim 3 wherein each clamp collar comprises:
a pair of ends, each end comprising a threaded aperture, the threads of the apertures matching like threads of the fasteners; and
an arched portion extending between the ends, the arched portion substantially matching the circumferential profile or outer diameter of the engine guard.

5. The boot rest of claim 4 wherein the body member is chromed.

6. The boot rest of claim 4 wherein the boot rest rubber member is comprised of a rubber of medium to high durometer.

7. The boot rest of claim 4 wherein the apertures of each clamp collar is self-threading relative to the threads of the fasteners.

8. The boot rest of claim 4 wherein an outermost projecting member of the rubber support insert comprises a lip which provides a surface that assists in urging a user's boot inwardly of the engine guard.

9. A boot rest for use with a motorcycle engine guard, the engine guard comprising a horizontal portion, a vertical portion and a curved portion that is disposed between the horizontal and vertical portions, the boot rest comprising:
a body member;
a rubber support insert;
a pair like-configured clamp collars; and
a plurality of like-configured fasteners;
wherein the boot rest is attachable to the curved portion of the engine guard, the engine guard further comprising a substantially tubular structure having a circumferential diameter.

10. The boot rest of claim 9 wherein the body member comprises:
a top surface, the top surface having a plurality of apertures defined in it;
an inner edge, the inner edge comprising a lowermost portion that defines an arched surface and a pair of vertically-disposed holes, the arched surface of the lowermost portion of the inner edge substantially matching the curve of the curved portion of the engine guard;
an outer edge, the outer edge comprising a lowermost portion having an arched surface and a pair of holes defined in the arched surface, the arched surface of the lowermost portion of the outer edge substantially matching the circumferential diameter of the engine guard; and
a cavity formed between forward and rearward edges of the body member, the edges being curved.

11. The boot rest of claim 10 wherein the rubber support insert comprises:
a top surface;
a plurality of projecting members, the projecting members extending upwardly from the top surface of the rubber member and the vertical profile of each upward projecting member matching the shape of a like-positioned aperture of the top surface of the body member; and
a bottom surface having a curved profile that substantially matches the curved portion of the engine guard.

12. The boot rest of claim 11 wherein each clamp collar comprises:
a pair of ends, each end comprising a threaded aperture, the threads of the apertures matching like threads of the fasteners; and
an arched portion extending between the ends, the arched portion substantially matching the circumferential diameter of the engine guard.

13. The boot rest of claim 12 wherein the body member is chromed.

14. The boot rest of claim 12 wherein the boot rest rubber member is comprised of a rubber of medium to high durometer.

15. The boot rest of claim 12 wherein the apertures of each clamp collar is self-threading relative to the threads of the fasteners.

16. The boot rest of claim 12 wherein an outermost projecting member of the rubber support insert comprises a lip which provides a surface that assists in urging a user's boot inwardly of the engine guard.
